(19) United States
(12) Patent Application Publication
(10) Pub. No.: US 2020/0160413 A1
(43) Pub. Date: May 21, 2020

(54) DYNAMIC FOOD PRICING ENGINE

(71) Applicant: Jason Rembert, Colorado Springs, CO (US)

(72) Inventor: Jason Rembert, Colorado Springs, CO (US)

(21) Appl. No.: 16/685,549

(22) Filed: Nov. 15, 2019

Related U.S. Application Data
(60) Provisional application No. 62/767,834, filed on Nov. 15, 2018.

(51) Int. Cl. G06Q 30/02; G06Q 20/40; G06N 20/00

(52) U.S. Cl. CPC G06Q 30/0283; G06N 20/00; G06Q 20/401; G06Q 30/0201

(57) ABSTRACT

Embodiments of the present disclosure relate generally to systems and methods for the dynamic pricing of food. The computer systems of the invention generally comprise at least a pricing engine and one or more of an application installed on a user computer and a computer system for setting and/or changing prices of food products. The systems and methods of the invention provide food prices for retail and/or wholesale food that considers variables that affect food pricing.

### CROSS-REFERENCE TO RELATED APPLICATION

This application claims the benefit of U.S. Provisional Patent Application 62/767,834, filed 15 Nov. 2018, the entirety of which is incorporated herein by reference.

### FIELD OF THE INVENTION

Embodiments of the present disclosure relate generally to systems and methods for pricing food, and more particularly to electronic computer systems enabling dynamic, continuous, and/or real-time pricing of food products based on various food product parameters. The computer systems of the invention generally comprise at least a pricing engine running on one or more servers and various services that calculate inputs to the pricing engine based on the food product parameter(s). In addition to enabling dynamic, continuous, and/or real-time pricing of food products based on various food product parameters, the systems and methods of the invention enable the creation of a detailed historical record of food prices and of predictive analytics for future food prices.

### BACKGROUND OF THE INVENTION

At present, there is no reliable and continuous system for the collection and dissemination of food price data in the United States, and thus there is little or no ability for buyers or sellers of food, or other persons with an interest in the food industry, to quantitatively understand food pricing trends in a way that would guide purchase/sale decisions. Indeed, the only authoritative source of food pricing data of any kind in the United States is provided by the U.S. Department of Agriculture (USDA), and is limited to a small set of commodity food products; the granularity of these data is poor, and often fails to account for variations in food product age, quality, location, and other similar food product variables.

In general, the prices of food products, and the prices of perishable food products in particular, undergo a relatively consistent cycle of changes; the prices of food products tend to be highest during an initial or original phase of the food product's usable life when first offered for sale, and then are reduced once the food product reaches certain ages. Moreover, food products are generally sold on at least one of three different markets (the retail market, the wholesale market, and the commodity market), each of which has a different pricing structure. As described above, the USDA tracks prices only in the commodity market, and even in that case tracks the prices of only a select few food products; food suppliers, such as farmers and ranchers, thus have no reliable industry source of information that would allow them to make informed and intelligent pricing decisions as to the retail or wholesale markets, or even as to products in the commodity market not covered by the USDA's data collection. There is also no reliable historical record of food prices across, e.g., the retail and wholesale markets, or even for many food prices in the commodity markets, that would allow food buyers and sellers, economists, emergency planning professionals, and others to gain a detailed quantitative understanding of how geographic location, food product quality, food product age, and so on affect food prices.

Moreover, lost food, defined in general terms as food that fails to be used for good purpose, represents an economic loss of at least $200 billion per year in the United States alone. Food loss can have many causes, including but not limited to ordering errors, cancellations of purchases or sales at short notice, cosmetic blemishes, and so on. Because many food products are perishable, owners of excess or unsold food have very little time to sell or donate this food, and as a result, much of the food loss in the United States is the result of these owners simply throwing away and sending to landfills food that cannot be, or has not been, sold. A large proportion of food loss in the United States could be avoided or mitigated by improving the quality of food pricing information available to food buyers and sellers, and particularly by providing an agile solution that updates and provides food product prices dynamically, continuously, and/or in real time. Even more advantageous would be a source of food product price information that incorporates data pertaining to food product defects, e.g. cosmetic blemishes and/or age, to allow for the development of a pricing standard for imperfect food, which at present usually goes unsold and ends up in landfills. Particularly, it would be desirable to provide a systematic source of pricing data that would enable food buyers and sellers to develop analytical models of changes in food prices over time, particularly with regard to the lifecycle of perishable food products; at present, there is no industry standard that assesses, quantitatively and with a high degree of accuracy, how prices of perishable food products change with the age of the food product, and such a standard would enable food buyers and sellers to avoid significant quantities of food loss due to spoilage of perishable food products.

Additionally, regular buyers of large quantities of food, such as restaurants, hotels, hospitals, prisons, and schools, are generally uninformed or underinformed as to prevailing prices for a given food product, in a given geographic location, and/or at a given time of year. This is due to an intentional lack of pricing transparency in the food distribution industry; a more transparent system of food pricing would improve the efficiency of purchasing and sale decisions and would result in prices that respond more rationally to changing conditions, and possibly to lower prices for buyers overall.

There is thus a need in the art for systems and methods that collect, assess, and analyze food product pricing variables to generate specific, highly granular food product pricing data dynamically, continuously, and/or in real time, and to provide such food product pricing data to authorized users upon request. It is further advantageous for such systems and methods to provide farmers and ranchers, individuals, restaurants, hospitality companies, caterers, and other institutions (e.g. hospitals, prisons, schools, etc.) with quantitative information pertaining to how food product characteristics, e.g. food product condition, location, and remaining usable life, affect food prices in the retail, wholesale, and/or commodity markets, to allow those who wish to buy or sell food to make more informed food purchasing and selling decisions.

### SUMMARY OF THE INVENTION

It is one aspect of the present invention to provide a method for displaying, in a graphical user interface, food pricing data, comprising (a) receiving, by a pricing engine server, a request for a food product price; (b) authenticating, by an authentication server, the request according to a secure authentication algorithm; (c) parsing, by the authentication server, the request to identify one or more request parameters contained within the request; (d) normalizing, by a normalization server, the one or more request parameters; (e) constructing, by the pricing engine server, one or more data structures, the one or more data structures collectively comprising the one or more normalized request parameters; (f) storing, by the pricing engine server, the one or more data structures in a computer memory; (g) parsing, by one or more pricing variable servers, at least one of the one or more data structures to determine one or more food pricing variables based on at least one of the one or more normalized request parameters; (h) calculating, by a price calculation server and according to a food pricing algorithm, a food product price based on the one or more food pricing variables; and (i) displaying, by the pricing engine server, the food product price in a graphical user interface.

In embodiments, at least two of the pricing engine server, the authentication server, the normalization server, the one or more pricing variable servers, and the price calculation server may be the same server.

In embodiments, each of the pricing engine server, the authentication server, the normalization server, the one or more pricing variable servers, and the price calculation server may be a separate server.

In embodiments, the secure authentication algorithm may be selected from the group consisting of OAuth and SAML.

In embodiments, at least one of the one or more request parameters may be selected from the group consisting of a food product name, a price format, a food product weight, and a geographic identifier.

In embodiments, the food pricing algorithm may comprise a deterministic food pricing equation.

In embodiments, the food pricing algorithm may comprise a machine learning algorithm. The machine learning algorithm may, but need not, be selected from the group consisting of TensorFlow, NaiveBayes, Logistic Regression, and Random Forest.

It is another aspect of the present invention to provide a computer system for facilitating trading of a food product, comprising a processor; and a memory coupled with and readable by the processor and storing therein a set of instructions which, when executed by the processor, causes the processor to facilitate trading of a food item by (a) receiving, by a pricing engine server, a request for a food product price; (b) authenticating, by an authentication server, the request according to a secure authentication algorithm; (c) parsing, by the authentication server, the request to identify one or more request parameters contained within the request; (d) normalizing, by a normalization server, the one or more request parameters; (e) constructing, by the pricing engine server, one or more data structures, the one or more data structures collectively comprising the one or more normalized request parameters; (f) storing, by the pricing engine server, the one or more data structures in a computer memory; (g) parsing, by one or more pricing variable servers, at least one of the one or more data structures to determine one or more food pricing variables based on at least one of the one or more normalized request parameters; (h) calculating, by a price calculation server and according to a food pricing algorithm, a food product price based on the one or more food pricing variables; and (i) displaying, by the pricing engine server, the food product price in a graphical user interface.

In embodiments, at least two of the pricing engine server, the authentication server, the normalization server, the one or more pricing variable servers, and the price calculation server may be the same server.

In embodiments, each of the pricing engine server, the authentication server, the normalization server, the one or more pricing variable servers, and the price calculation server may be a separate server.

In embodiments, the secure authentication algorithm may be selected from the group consisting of OAuth and SAML.

In embodiments, at least one of the one or more request parameters may be selected from the group consisting of a food product name, a price format, a food product weight, and a geographic identifier.

In embodiments, the food pricing algorithm may comprise a deterministic food pricing equation.

In embodiments, the food pricing algorithm may comprise a machine learning algorithm. The machine learning algorithm may, but need not, be selected from the group consisting of TensorFlow, NaiveBayes, Logistic Regression, and Random Forest.

It is another aspect of the present invention to provide a computer system for facilitating trading of a food product, comprising a pricing engine; an authentication service; a normalization service; at least one food product pricing variable service; and a price calculation service, wherein the pricing engine receives a data structure comprising user credentials and a food product pricing request from a user computer, parses the data structure, and communicates the user credentials and the at least one price request parameter to the authentication service, wherein the authentication service applies a secure authentication algorithm to the user credentials, parses the food product pricing request for at least one request parameter, and communicates a validation and the at least one request parameter to the pricing engine, wherein the pricing engine communicates the at least one request parameter to the normalization service, wherein the normalization service normalizes the at least one request parameter and communicates one or more normalized parameters to the pricing engine, wherein the pricing engine communicates at least one of the one or more normalized parameters to the at least one food product pricing variable service, wherein the at least one food product pricing variable service applies a set of logical filtering elements to the at least one normalized parameter to produce a filtered food pricing variable and communicates the filtered food pricing variable to the pricing engine, wherein the pricing engine communicates the filtered food pricing variable to the price calculation service, wherein the price calculation service calculates a food product price based on the filtered food pricing variable according to a pricing algorithm and communicates the food product price to the pricing engine, and wherein the pricing engine displays an indicator in a graphical user interface of the user computer, the indicator corresponding to the food product price.

In embodiments, the secure authentication algorithm may be selected from the group consisting of OAuth and SAML.

In embodiments, the pricing algorithm may comprise a deterministic pricing equation. In embodiments, the pricing algorithm may comprise a machine learning algorithm.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a generalized diagram of a system for dynamically, continuously, and/or in real time generating food product pricing data and providing such data to a user via the Internet, according to embodiments of the present invention.

FIG. 4 is a flowchart illustrating method steps for displaying food pricing data in a graphical user interface, according to embodiments of the present invention.

In the appended figures, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION OF THE INVENTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits various known structures and devices. This omission is not to be construed as a limitation of the scopes of the claims. Rather, the ensuing description of the exemplary embodiments will provide an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored; such media include, but are not limited to, a blockchain.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

As used herein, the terms “primary market” and “primary food market” are interchangeable and each refer to conventional wholesale or retail markets for the purchase and sale of food products. By way of non-limiting example, farmers, ranchers, grocery stores, wholesale food distributors, and commercial food services are generally sellers in the primary market, and individuals, restaurants, caterers, hospitals, prisons, and schools are generally buyers in the primary market.

As used herein, the term “excess food” refers to any food product that cannot be sold on the primary market, or that has already been sold on the primary market but whose purchaser on the primary market desires to resell.

As used herein, the terms “secondary market” and “secondary food market” are interchangeable and each refer to markets for the purchase and sale of excess food.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJS™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. In additional embodiments, the disclosed methods may be implemented in conjunction with functional programming. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

Embodiments of the disclosure provide systems and methods for generating and/or providing food product pricing data dynamically, continuously, and/or in real time. Generally speaking, embodiments described herein provide computer systems enabling users to access reliable, specific, highly granular food product pricing data that is updated dynamically, continuously, and/or in real time. The computer systems of the invention generally comprise at least a user-operable application and a pricing engine, which may take the form of an application programming interface (API). More specifically, preferred embodiments comprise a website and/or mobile application, a web browser, a pricing engine, an authentication API or service, a normalization API or service, one or more food product pricing variable APIs or services, and a price calculation service, which collectively enable potential buyers and potential sellers of food and other persons with an interest in food pricing to evaluate the price, and changes in the price, of one or more specific food products in a retail, wholesale, and/or commodity market.

Various additional details of embodiments of the present disclosure will be described below with reference to the figures. While the flowchart(s) will be discussed and illustrated in relation to a particular sequence of events, it should be appreciated that changes, additions, and omissions to this sequence can occur without materially affecting the operation of the disclosed embodiments, configuration, and aspects.

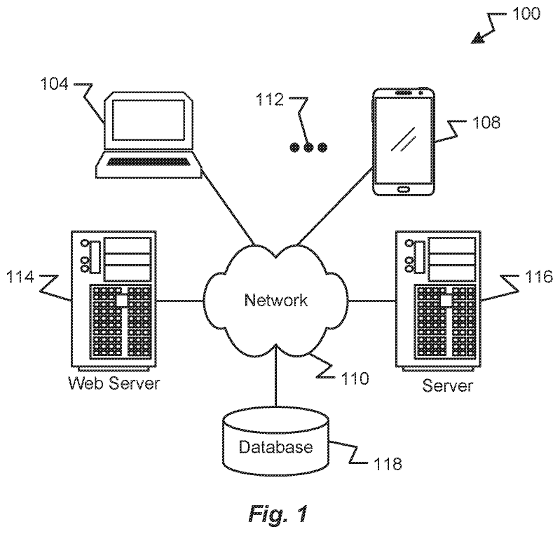

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C #®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

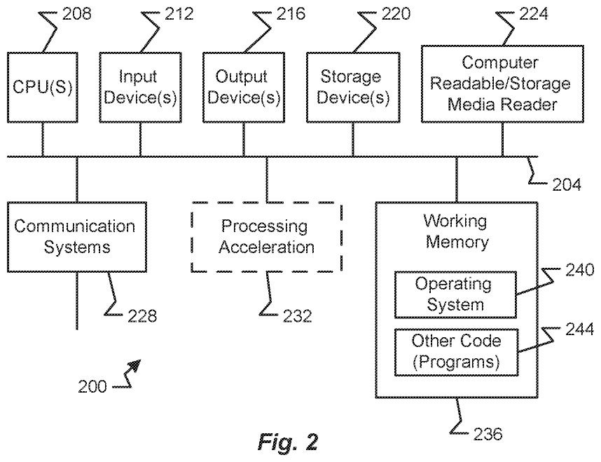

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244.

It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJS™ processors, other industry-equivalent processors, and may perform computational functions using any known or future-developed standard, instruction set, libraries, and/or architecture.

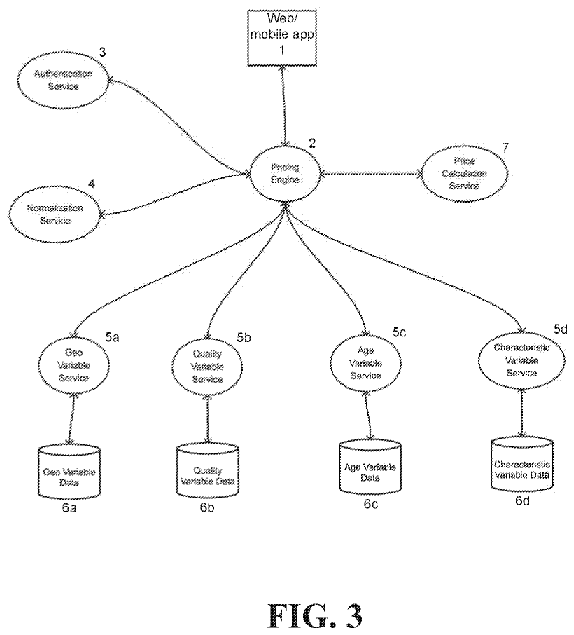

Referring now to FIG. 3, an embodiment of a computer system for dynamic pricing of a food product is illustrated. The system interacts with (and/or, in some embodiments, may comprise) a web and/or mobile application 1, and comprises a pricing engine 2, an authentication service 3, a normalization service 4, at least one food product pricing variable service 5a,b,c,d communicating with at least one source of food product pricing data 6a,b,c,d, and a price calculation service 7. Each of the pricing engine 2, the authentication service 3, the normalization service 4, the food product pricing variable service(s) 5, and the price calculation service 7 is embodied within a server; in some embodiments any two or more of these elements may be embodied within the same server, while in other embodiments each of these elements may be embodied within a separate server. Furthermore, each food product pricing variable service 5 and a respective source of food product pricing data 6 may be embodied in the same device or in separate devices in wired or wireless communication; any single food product pricing variable service 5 may, but need not, retrieve data from multiple sources of food product pricing data 6; and any single source of food product pricing data 6 may, but need not, be associated with multiple food product pricing variable services 5.

Where the web and/or mobile application 1 is a web application, users may be able to access the web application from any suitable web browser in conjunction with which the web application is adapted and/or configured to run, including but not limited to Google Chrome, Internet Explorer, Mozilla Firefox, and Safari. Additionally and/or alternatively, where the web and/or mobile application 1 is a mobile application, users may download and install the mobile application from any suitable source, including, by way of non-limiting example, via a web browser or a mobile application marketplace.

The web and/or mobile application 1, upon initial use by a particular user, may generally query the user for information that may be used to identify the user to any one or more of the pricing engine 2, the authentication service 3, the normalization service 4, the food product pricing variable services 5, and the price calculation service 7. This identifying information may, in various embodiments, include any one or more of an API key, an email address, a mailing address or a part thereof (such as a city and state and/or ZIP code), a telephone number, and/or a unique user identifier. The web and/or mobile application 1 may then store this identifying information so that the user may be identifiable to the system whenever the user opens the web and/or mobile application 1. As described in greater detail below, any one or more of the pricing engine 2, the authentication service 3, the normalization service 4, the food product pricing variable services 5, and the price calculation service 7 may use the identifying information to pair the user with relevant food product pricing variables, particularly food product pricing variables relating to the food product's location.

The web and/or mobile application 1 and various other components of the system may be configured or adapted to allow a single user to be identified on any of several various devices using the identifying information provided to the pricing engine. By way of non-limiting example, a single user account, linked with identifying information associated with a specific individual user, may be accessible, simultaneously or otherwise, from a home computer, a work computer, and a mobile device, any of which may run a suitable embodiment of the web and/or mobile application 1. In this way, any user can easily utilize the system from any conveniently accessible device, because his or her identifying information “follows” him or her.

The users of the web and/or mobile application may be any person or entity with an interest in obtaining reliable, systematic, highly granular food pricing data. As a first non-limiting example, services that facilitate purchases and sales of lost and/or excess food may use the systems of the present invention to price the lost and/or excess food. As a second non-limiting example, food producers, e.g. farmers and ranchers, may use the systems of the present invention to determine how to price the food products they produce when selling to distributors, wholesalers, etc., and particularly to determine how to price imperfect food products, e.g. fruits and vegetables with cosmetic blemishes or older perishable food products. As a third non-limiting example, food sellers, e.g. food producers, food distributors, food wholesalers, and food retailers such as grocery stores, may use the systems of the present invention to assess how the prevailing market price of a particular food product varies with, e.g., the age of the food product, and to benefit from analytical models automatically developed by the pricing engine that allow food sellers to continually and systematically vary the price of the food product over time to reflect the changing condition of the food product. As a fourth non-limiting example, individual consumers and other food buyers, e.g. operators of restaurants, hotels, and other institutions (such as hospitals, prisons, schools, etc.) may use the systems of the present invention to determine the prevailing market price of a particular food product in a particular location at a particular time, especially for the purpose of assessing whether to agree to a purchase of a food product based on deviations from the prevailing market price. As a fifth non-limiting example, purchasers of lost and/or excess food, e.g. individuals or entities that manufacture food for pets and/or livestock animals, may use the systems of the present invention to find and price lost and/or excess food products, and particularly to determine how much to pay for a lost and/or excess food product of a desired quality.

The pricing engine 2 is a web service, application programming interface (API), or similar service hosted on a computer remote from the user computer on which the web and/or mobile application 1 is running. The purpose of the pricing engine 2 is to automatically collect, parse, and transmit the various signals and forms of data necessary to generate food product pricing data and display the food product pricing data in a graphical user interface (GUI) of the web/and or mobile application 1 of the user. In embodiments, when commanded to do so by the user, the web and/or mobile application 1 may call the pricing engine 2 and transmit to the pricing engine 2 a request for food product pricing data, which prompts the pricing engine 2 to generate and/or collect from other services the information necessary to generate the requested food product pricing data and display the food product pricing data in the GUI of the web and/or mobile application 1 of the user and/or provide the food product pricing data to the web and/or mobile application 1 for use in further calculations or other desirable uses.

In some embodiments, the web and/or mobile application 1 may be configured, either automatically or based on an input by the user, to call the pricing engine 2 at regular intervals, e.g. at least once per week, at least once per day, and/or at least once per hour, to obtain pricing data pertaining to one or more food products. This functionality may be desirable, by way of non-limiting example, for ensuring that the pricing engine 2 updates the price of one or more food products dynamically, continually, and/or in real time. The web and/or mobile application 1 may also be configurable to provide an alert to a user when pricing data returned by the pricing engine 2 represent a change in the price of a food product exceeding a predetermined threshold.

Whether generated automatically or based on inputs by the user, the request for food product pricing data contained in the call by the web and/or mobile application 1 to the pricing engine 2 generally comprises at least one request parameter, which typically represents information pertaining to a preselected food product or to a potential purchase or sale thereof. By way of non-limiting example, request parameters included in the request may include a food product name, a food product price class (e.g. corresponding to whether the user desires to buy the food product in the retail, wholesale, and/or commodity market), a date, a season (e.g. winter, spring, summer, fall), a food product weight, a food product age, a food product quality parameter (e.g. corresponding to an industry standard food quality grade, such as a #1, #2, or #3 grade for tomatoes, or a qualitative description of the desirability of the food product), a geographic identifier corresponding to a location of the user and one or more other food product characteristics.

When commanded to generate a request for food product pricing data, either automatically or by inputs from the user, the web and/or mobile application 1 may automatically generate a URL or portion thereof that concatenates, encodes, and/or formats the one or more request parameters. By way of non-limiting example, where the web and/or mobile application 1 identifies a product name as “Chinook salmon,” a product price class as “wholesale,” a season as “fall,” a product weight as three pounds, a product age as 14 days, a product quality as “perfect,” a ZIP code of the food product's location as 32789, and three product characteristics as “frozen,” “wild,” and “organic,” the web and/or mobile application 1 may generate a URL or partial URL comprising the string: “product=Chinook %20Salmon&pclass=wholesale& season=fall&weight=3lb&age=14 days&qual ity=perfect&geo=32789&char=frozen %2cwild %2corganic” (or a similar string).

It is to be expressly understood that the web and/or mobile application 1 may (but need not) be, and/or the pricing engine 2 may (but need not) be configured to operate in conjunction with, a browser extension of a web browser of the user that provides food purchasing information to the user while the user browses a food purchasing web site. A non-limiting example of such a browser extension is described in U.S. Provisional Patent Application 62/721,972, filed 23 Aug. 2018, the entirety of which is incorporated herein by reference.

After generating a URL string in which the request parameters are formatted or encoded, the web and/or mobile application 1 may construct a URL incorporating this string, which is then incorporated into the call to the pricing engine 2. Generally, the call by the web and/or mobile application 1 to the pricing engine 2 can take the form of a call to a secure representational state transfer (REST) service via any standard protocol for invoking a REST service, including but not limited to a request for a JavaScript Open Notation (JSON) file, but other suitable software architectures and data interchange formats will be apparent to those of ordinary skill in the art and are within the scope of the present disclosure.

Upon receiving the request for food product pricing data from the web and/or mobile application 1, the pricing engine 2 first evaluates credentials of the user sent by the web and/or mobile application 1 by passing the credentials to an authentication service 3, which validates that the request originates from a valid requestor by means of a secure authentication standard, such as, by way of non-limiting example, OAuth and/or Security Assertion Markup Language (SAML). Once the pricing engine 2 receives the validation from the authentication service 3, it then begins generating, receiving, requesting, and/or transmitting the information necessary to respond to the request and provide food product pricing data to the user via the GUI of the web and/or mobile application 1, as described in further detail below.

First, the pricing engine 2 communicates some or all of the request parameters to a normalization service 4. The normalization service 4 applies an algorithm to the relevant request parameters to convert them into standard formats and values and consistent units of measure, so as to allow any one or more of the pricing engine 2, the food product pricing variable services 5, and the price calculation service 7 to filter and/or sort variables and data pertaining to the food product in a consistent manner and compare and/or contrast similar and/or different food products. By way of non-limiting example, if any one or more of the pricing engine 2, the food product pricing variable services 5, and the price calculation service 7 are configured to require that a food product weight be input in units of ounces rather than pounds, the normalization service 4 may apply an algorithm to convert the food product weight of the example described above (three pounds, or “31b” in the URL) to the equivalent in ounces (i.e. 48 ounces). After normalizing the request parameters, the normalization service 4 then passes the normalized request parameters back to the pricing engine 2.

Upon receiving the normalized request parameters from the normalization service 4, the pricing engine 2 constructs a data structure comprising the normalized request parameters and stores this data structure in a computer memory. Storing the data structure in a computer memory allows the pricing engine 2 to subsequently and asynchronously send the data structure, or a portion of the data structure comprising one or more normalized request parameters, to one or more food product pricing variable services 5, each of which applies an algorithm to the one or more received normalized request parameters to determine a food product pricing variable corresponding to one or more normalized request parameters. As illustrated in FIG. 1, there may be multiple food product pricing variable services 5, each of which is configured to receive less than all of the normalized request parameters and communicate a different food product pricing variable back to the pricing engine 2, and in turn the pricing engine 2 may be configured to send less than all of the normalized request parameters to any one or more of the food product pricing variable services 5. Although in FIG. 1 there are four food product pricing variable services 5, which are responsible for determining a geographic pricing variable, a food product quality pricing variable, a food product age pricing variable, and one or more food product characteristic pricing variables, it is to be expressly understood that more or fewer food product pricing variable services 5, determining more, fewer, or different food product pricing variables, may be provided within the scope of the present invention. The food product pricing variable services 5a,b,c,d may communicate with remote and/or separate repositories of food price data 6a,b,c,d, as illustrated in FIG. 1, and/or may be integrated with a collection of food price data stored on the same device.

The food price data repositories 6, and/or the food product pricing variable services 5 themselves, may obtain food price data from any of a variety of sources. As a first non-limiting example, retail prices for food products may be collected from the websites of food retailers, e.g. grocery stores. As a second non-limiting example, wholesale prices for food products may be collected from the websites of food wholesalers, e.g. commercial food distributors. As a third non-limiting example, commodity prices for food products may be collected from the pricing data sources provided by the U.S. Department of Agriculture (USDA). As a fourth non-limiting example, regular buyers of large quantities of food, e.g. persons or entities that operate restaurants, hotels, and other institutions (hospitals, prisons, schools, etc.), may anonymously provide the prices paid for various food items via the web and/or mobile application 1. As a fifth non-limiting example, food producers, e.g. farmers and ranchers, may anonymously provide the selling prices for various food items via the web and/or mobile application 1. As a sixth non-limiting example, individuals may anonymously provide the prices paid for various food items via the web and/or mobile application 1. As a seventh non-limiting example, the food price data repositories 6, and/or the food product pricing variable services 5 themselves, may collect additional food pricing data from other third-party APIs and data sources.

Each of the one or more food product pricing variable services 5 will apply one or more algorithms to one or more of the normalized request parameters received by that food product pricing variable service 5 to determine food product pricing variables therefrom. Specifically, the one or more algorithms will be implemented in such a way as to account for differences in food product characteristics between the food product that is the subject of the request and the one or more food product(s) for which pricing data are available. As a first non-limiting example, an algorithm may be applied by the food product pricing variable service(s) 5 to the normalized request parameters to account for variations in the geographic location of a food product. As a second non-limiting example, an algorithm may be applied by the food product pricing variable service(s) 5 to the normalized request parameters to account for variations in the quality of a food product. As a third non-limiting example, an algorithm may be applied by the food product pricing variable service(s) 5 to the normalized request parameters to account for variations in the age of a food product. As a fourth non-limiting example, an algorithm may be applied by the food product pricing variable service(s) 5 to the normalized request parameters to account for variations in the storage temperature of a food product. As a fifth non-limiting example, an algorithm may be applied by the food product pricing variable service(s) 5 to the normalized request parameters to account for variations in the seasonality of a food product. As a sixth non-limiting example, an algorithm may be applied by the food product pricing variable service(s) 5 to the normalized request parameters to account for variations in certain other characteristics of a food product (e.g. organic vs. non-organic, grass-fed, fresh vs. frozen, etc.) that may affect the price of the food product.

Non-limiting examples of food product pricing variables generated by the one or more food product pricing variable services 5 are described below.

### Example 1: Food Product Age Variable

The food product pricing variable services 5 may compute an expected lifetime of a food product based on the received food price data, which in turn allows for the determination of a mathematical relationship between the age of the food product and its price. By way of non-limiting example, the relationship between age and price of a perishable food product may be logarithmic, while the relationship between age and price of a non-perishable food product may be linear.

Generally speaking, food products that have been harvested, manufactured, or first offered for sale more recently are more desired in the marketplace and thus command a higher price than food products that have been harvested, manufactured, or first offered for sale less recently (although there may be exceptions, such as, e.g., certain high-end alcoholic beverages or cheeses, which often become more desirable after aging). Thus, for example, the algorithm will determine a larger age variable for tomatoes that have been available for purchase for one day than for tomatoes that have been available for purchase for seven days. As the food product (in this example, tomatoes) continues to age, the algorithm may then determine a still smaller age variable when the tomatoes reach an age at which they cannot be sold in grocery stores and may be sold on a secondary market (e.g. to supply makers of tomato juice or tomato soup), and decline still further when the tomatoes reach an age at which they are saleable only to purchasers of scrap and/or waste produce (e.g. pig farmers, composting companies). The exact quantitative relationship between age and price, and thus the relationship between age and the age-related variable, for a given food product may be determined empirically from collected food pricing data available to the food product pricing variable service(s) 5.

### Example 2: Food Product Quality Variable

The food product pricing variable services 5 may determine a quality grade for a food product based on the received food price data, which in turn allows for the determination of a mathematical relationship between the quality of the food product and its price. Often, but not always, the quality grade determined by the food product pricing variable services 5 may be related to a quality grade assigned to the food product by industry or government inspectors. By way of non-limiting example, at harvesting, tomatoes are generally assigned a grade of #1 (“perfect for market”), #2 (“imperfect but edible”), and #3 (“scrap/compost”); the algorithm may thus assign a certain quality variable value to #1 tomatoes, a lower quality variable value to #2 tomatoes, and a still lower quality variable value to #3 tomatoes. The exact quantitative relationship between quality and price, and thus the relationship between quality and the quality-related pricing variable, for a given food product may be determined empirically from collected food pricing data available to the food product pricing variable service(s) 5.

### Example 3: Food Product Location Variable

The food product pricing variable services 5 may determine a pricing variable related to how closely to a point of origin a food product is being sold. Often, but not always, food products are more widely available, and thus lower in price, when sold relatively close to where they were harvested or manufactured. By way of non-limiting example, navel oranges are likely to be less expensive in Orlando, Fla. than in Anchorage, Ak., while for Chinook salmon the relationship is likely to be the opposite. The exact quantitative relationship between location and price, and thus the relationship between location and the location-related pricing variable, for a given food product may be determined empirically from collected food pricing data available to the food product pricing variable service(s) 5.

### Example 4: Food Product Seasonality Variable

The food product pricing variable services 5 may determine a pricing variable related to whether a given food product is “in season.” Often, but not always, food products are more widely available, and thus lower in price, when sold in the season immediately following their harvest. By way of non-limiting example, peaches are generally most widely available in the late summer, and their prices reflect this wider availability. Note that seasonality is related to, but distinct from, the age or quality of a food product due to seasonal changes in demand; by way of non-limiting example, the price of ice cream may (regardless of age or quality) be significantly higher in the summer than at other times, the price of a pumpkin may (regardless of age or quality) be significantly higher shortly before Halloween than at other times, and the price of a whole turkey may (regardless of age or quality) be significantly higher shortly before Thanksgiving than at other times. The exact quantitative relationship between season and price, and thus the relationship between season and the seasonality-related pricing variable, for a given food product may be determined empirically from collected food pricing data available to the food product pricing variable service(s) 5.

### Example 5: Food Product Characteristic Variable

The food product pricing variable services 5 may determine one or more pricing variables related to various additional characteristics of a food product that affect the food product's price. By way of non-limiting examples, such characteristics may include fresh vs. frozen, organic vs. non-organic, grass-fed, gluten-free, kosher, halal, and so on. The exact quantitative relationship between each of these characteristics and price, and thus the relationship between each of these characteristics and an associated pricing variable, for a given food product may be determined empirically from collected food pricing data available to the food product pricing variable service(s) 5.

After determining the various food product pricing variables, the food product pricing variable service(s) 5 return the food product pricing variables to the pricing engine 2, which then passes them to the price calculation service 7. The price calculation service 7 then determines, based on the food product pricing variables, a price of the food product that is the subject of the request; the price calculation service 7 passes this price back to the pricing engine, which in turn displays the price in the GUI of the web and/or mobile application 1.

In some embodiments, the price calculation service 7 may determine the price of the food product according to a deterministic equation in which the food product pricing variables determined by the food product pricing variable services 5 are used as weights or coefficients, e.g., as a non-limiting example, an equation of the form Price=baseline×price class variable×seasonality variable×weight variable×age variable×quality variable×location variable×characteristic variable× . . . . Additionally or alternatively, the price calculation service 7 may employ any one or more machine learning algorithms, using historical food prices as training data to construct equations and/or weighting the variables in an iterative manner, which may enable more complex, complete, and/or nuanced relationships between pricing variables and food prices. Machine learning algorithms employed by the price calculation service 7 of the present invention may be either supervised or unsupervised, and may include, by way of non-limiting example, TensorFlow, NaiveBayes, Logistic Regression, and Random Forest.

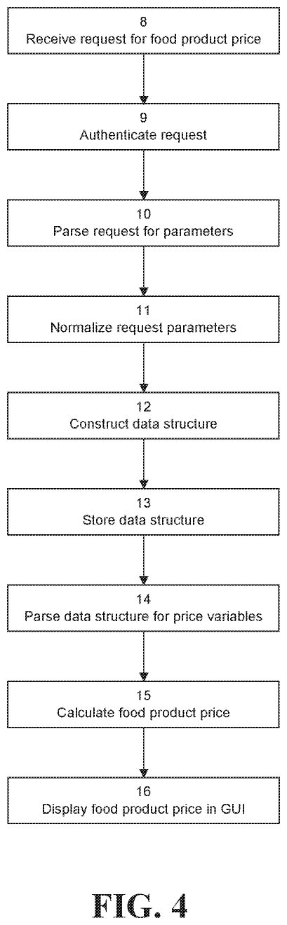

Referring now to FIG. 4, the interactions between the web and/or mobile application 1, the pricing engine 2, the authentication service 3, the normalization service 4, the at least one food product pricing variable service 5, the least one source of food product pricing data 6, and the price calculation service 7 are illustrated in more detail. Specifically, these interactions form a method comprising at least a first step 8, a second step 9, a third step 10, a fourth step 11, a fifth step 12, a sixth step 13, a seventh step 14, an eighth step 15, and a ninth step 16.

In the first step 8, a request for a food product price is received. Generally, the call by the web and/or mobile application 1 to the pricing engine 2 can take the form of a call to a secure representational state transfer (REST) service via any standard protocol for invoking a REST service, including but not limited to a request for a JavaScript Open Notation (JSON) file, but other suitable software architectures and data interchange formats will be apparent to those of ordinary skill in the art and are within the scope of the present disclosure.

In the second step 9, the request is authenticated. Upon receiving the request for food product pricing data from the web and/or mobile application 1, the pricing engine 2 first evaluates credentials of the user sent by the web and/or mobile application 1 by passing the credentials to an authentication service 3, which validates that the request originates from a valid requestor by means of a secure authentication standard, such as, by way of non-limiting example, OAuth and/or Security Assertion Markup Language (SAML).

In the third step 10, the request is parsed to determine request parameters. The request for food product pricing data contained in the call by the web and/or mobile application 1 to the pricing engine 2 generally comprises at least one request parameter, which typically represents information pertaining to a preselected food product or to a potential purchase or sale thereof. By way of non-limiting example, request parameters included in the request may include a food product name, a food product price class (e.g. corresponding to whether the user desires to buy the food product in the retail, wholesale, and/or commodity market), a date, a season (e.g. winter, spring, summer, fall), a food product weight, a food product age, a food product quality parameter (e.g. corresponding to an industry standard food quality grade, such as a #1, #2, or #3 grade for tomatoes, or a qualitative description of the desirability of the food product), a geographic identifier corresponding to a location of the user and one or more other food product characteristics.

When commanded to generate a request for food product pricing data, either automatically or by inputs from the user, the web and/or mobile application 1 may automatically generate a URL or portion thereof that concatenates, encodes, and/or formats the one or more request parameters. By way of non-limiting example, where the web and/or mobile application 1 identifies a product name as “Chinook salmon,” a product price class as “wholesale,” a season as “fall,” a product weight as three pounds, a product age as 14 days, a product quality as “perfect,” a ZIP code of the food product's location as 32789, and three product characteristics as “frozen,” “wild,” and “organic,” the web and/or mobile application 1 may generate a URL or partial URL comprising the string: “product=Chinook %20Salmon&pclass=wholesale&season=fall&weight=3lb&age=14 days&qual ity=perfect&geo=32789&char=frozen %2cwild %2corganic” (or a similar string). The pricing engine 2 is configured to parse such a URL or partial URL to identify the request parameters and ensure that they are validly configured.

In the fourth step 11, the request parameters are normalized. The pricing engine 2 communicates some or all of the request parameters to a normalization service 4. The normalization service 4 applies an algorithm to the relevant request parameters to convert them into standard formats and values and consistent units of measure, so as to allow any one or more of the pricing engine 2, the food product pricing variable services 5, and the price calculation service 7 to filter and/or sort variables and data pertaining to the food product in a consistent manner and compare and/or contrast similar and/or different food products. By way of non-limiting example, if any one or more of the pricing engine 2, the food product pricing variable services 5, and the price calculation service 7 are configured to require that a food product weight be input in units of ounces rather than pounds, the normalization service 4 may apply an algorithm to convert the food product weight of the example described above (three pounds, or “31b” in the URL) to the equivalent in ounces (i.e. 48 ounces). After normalizing the request parameters, the normalization service 4 then passes the normalized request parameters back to the pricing engine 2.

In fifth and sixth steps 12 and 13, a data structure is constructed and stored. The pricing engine 2 constructs a data structure comprising the normalized request parameters and stores this data structure in a computer memory. Storing the data structure in a computer memory allows the pricing engine 2 to subsequently and asynchronously send the data structure, or a portion of the data structure comprising one or more normalized request parameters, to one or more food product pricing variable services 5, each of which applies an algorithm to the one or more received normalized request parameters to determine a food product pricing variable corresponding to one or more normalized request parameters. As illustrated in FIG. 1, there may be multiple food product pricing variable services 5, each of which is configured to receive less than all of the normalized request parameters and communicate a different food product pricing variable back to the pricing engine 2, and in turn the pricing engine 2 may be configured to send less than all of the normalized request parameters to any one or more of the food product pricing variable services 5. Although in FIG. 1 there are four food product pricing variable services 5, which are responsible for determining a geographic pricing variable, a food product quality pricing variable, a food product age pricing variable, and one or more food product characteristic pricing variables, it is to be expressly understood that more or fewer food product pricing variable services 5, determining more, fewer, or different food product pricing variables, may be provided within the scope of the present invention. The food product pricing variable services 5a,b,c,d may communicate with remote and/or separate repositories of food price data 6a,b,c,d, as illustrated in FIG. 1, and/or may be integrated with a collection of food price data stored on the same device.

In the seventh step 14, the data structure is parsed for pricing variables. The food price data repositories 6, and/or the food product pricing variable services 5 themselves, may obtain food price data from any of a variety of sources. As a first non-limiting example, retail prices for food products may be collected from the websites of food retailers, e.g. grocery stores. As a second non-limiting example, wholesale prices for food products may be collected from the websites of food wholesalers, e.g. commercial food distributors. As a third non-limiting example, commodity prices for food products may be collected from the pricing data sources provided by the U.S. Department of Agriculture (USDA). As a fourth non-limiting example, regular buyers of large quantities of food, e.g. persons or entities that operate restaurants, hotels, and other institutions (hospitals, prisons, schools, etc.), may anonymously provide the prices paid for various food items via the web and/or mobile application 1. As a fifth non-limiting example, food producers, e.g. farmers and ranchers, may anonymously provide the selling prices for various food items via the web and/or mobile application 1. As a sixth non-limiting example, individuals may anonymously provide the prices paid for various food items via the web and/or mobile application 1. As a seventh non-limiting example, the food price data repositories 6, and/or the food product pricing variable services 5 themselves, may collect additional food pricing data from other third-party APIs and data sources.

Each of the one or more food product pricing variable services 5 will apply one or more algorithms to one or more of the normalized request parameters received by that food product pricing variable service 5 to determine food product pricing variables therefrom. Specifically, the one or more algorithms will be implemented in such a way as to account for differences in food product characteristics between the food product that is the subject of the request and the one or more food product(s) for which pricing data are available. As a first non-limiting example, an algorithm may be applied by the food product pricing variable service(s) 5 to the normalized request parameters to account for variations in the geographic location of a food product. As a second non-limiting example, an algorithm may be applied by the food product pricing variable service(s) 5 to the normalized request parameters to account for variations in the quality of a food product. As a third non-limiting example, an algorithm may be applied by the food product pricing variable service(s) 5 to the normalized request parameters to account for variations in the age of a food product. As a fourth non-limiting example, an algorithm may be applied by the food product pricing variable service(s) 5 to the normalized request parameters to account for variations in the storage temperature of a food product. As a fifth non-limiting example, an algorithm may be applied by the food product pricing variable service(s) 5 to the normalized request parameters to account for variations in the seasonality of a food product. As a sixth non-limiting example, an algorithm may be applied by the food product pricing variable service(s) 5 to the normalized request parameters to account for variations in certain other characteristics of a food product (e.g. organic vs. non-organic, grass-fed, fresh vs. frozen, etc.) that may affect the price of the food product. In these and other embodiments, the food product pricing variable service(s) 5 is thus configured to parse the data structure (or portion thereof) received from the pricing engine 2 for one or more request parameters relevant to the algorithms applied by the food product pricing variable service(s) 5.

In the eighth step 15, a food product price is calculated. After determining the various food product pricing variables, the food product pricing variable service(s) 5 return the food product pricing variables to the pricing engine 2, which then passes them to the price calculation service 7. The price calculation service 7 then determines, based on the food product pricing variables, a price of the food product that is the subject of the request.

In some embodiments, the price calculation service 7 may determine the price of the food product according to a deterministic equation in which the food product pricing variables determined by the food product pricing variable services 5 are used as weights or coefficients, e.g., as a non-limiting example, an equation of the form Price=baseline×price class variable×seasonality variable×weight variable×age variable×quality variable×location variable×characteristic variable× . . . . Additionally or alternatively, the price calculation service 7 may employ any one or more machine learning algorithms, using historical food prices as training data to construct equations and/or weighting the variables in an iterative manner, which may enable more complex, complete, and/or nuanced relationships between pricing variables and food prices. Machine learning algorithms employed by the price calculation service 7 of the present invention may be either supervised or unsupervised, and may include, by way of non-limiting example, TensorFlow, NaiveBayes, Logistic Regression, and Random Forest.

In the ninth step 16, the food product price is displayed in a graphical user interface. The price calculation service 7 passes the calculated food product price back to the pricing engine, which in turn displays the price in the GUI of the web and/or mobile application 1.

The methods and systems of the present invention may, in certain embodiments, also be operable to provide a comprehensive store of food product pricing data that may be created and maintained as a result of the calculation of prices by the pricing engine. As the pricing engine calculates prices for a variety of food products, such pricing data may be stored on or by any suitable storage medium or method, including but not limited to a blockchain medium or method. This store of food product pricing data may be valuable as a historical database and as a record by which to assess how various factors, including but not limited to food product location, food product quality, and food product age, affect food product prices. The store of food product pricing data may be accessible via an API and a GUI, which may be the same as or different from the API and GUI described in preceding paragraphs.

The store of food product pricing data may further enable the methods and systems of the present invention, and in particular the pricing engine, to automatically predict or project the prices of food products in the future by assessing how food product pricing variables have changed over time in the past and how such changes have affected food product prices. The predictive analytics by which the pricing engine predicts future food product prices may, as a result of the granularity of the data, be specific to individual food products and/or to each of the three separate markets (commodity, wholesale, retail) in which food products are sold. By assessing how various food product characteristics individually affect the price of the food product, the future price of the food product may thus be determined with greater accuracy and greater specificity; by way of non-limiting example, the future price of a whole turkey estimated by the food product pricing engine may vary based on any combination of a wide variety of factors (organic, antibiotic-free, hormone-free, etc.) in any of the three markets. The methods and systems of the present invention thus provide for predicting and/or projecting the future prices of a food product having any and every combination of food product characteristics.

As described above, the creation of a store of historical food pricing data is a distinct advantage of the present invention not provided by any method or system of the prior art. At present, few or no historical pricing data are available for most food products, especially in the wholesale and retail markets, and no source provides historical pricing data with the degree of granularity (i.e. with respect to individual food product characteristics) enabled by the present invention. The most comprehensive effort to track food product prices, conducted by the USDA, is applicable to only a small selection of products solely in the commodity market, and is not granular with respect to food product age, location, quality, characteristics, etc. These granular data are valuable not only to food buyers and sellers, but also to economic analysts, emergency planning professionals, commodity futures traders, and so on.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method for displaying, in a graphical user interface, food pricing data, comprising:
(a) receiving, by a pricing engine server, a request for a food product price;
(b) authenticating, by an authentication server, the request according to a secure authentication algorithm;
(c) parsing, by the authentication server, the request to identify one or more request parameters contained within the request;
(d) normalizing, by a normalization server, the one or more request parameters;
(e) constructing, by the pricing engine server, one or more data structures, the one or more data structures collectively comprising the one or more normalized request parameters;
(f) storing, by the pricing engine server, the one or more data structures in a computer memory;
(g) parsing, by one or more pricing variable servers, at least one of the one or more data structures to determine one or more food pricing variables based on at least one of the one or more normalized request parameters;
(h) calculating, by a price calculation server and according to a food pricing algorithm, a food product price based on the one or more food pricing variables; and
(i) displaying, by the pricing engine server, the food product price in a graphical user interface.

2. The method of claim 1, wherein at least two of the pricing engine server, the authentication server, the normalization server, the one or more pricing variable servers, and the price calculation server are the same server.

3. The method of claim 1, wherein each of the pricing engine server, the authentication server, the normalization server, the one or more pricing variable servers, and the price calculation server is a separate server.

4. The method of claim 1, wherein the secure authentication algorithm is selected from the group consisting of OAuth and SAML.

5. The method of claim 1, wherein at least one of the one or more request parameters is selected from the group consisting of a food product name, a price format, a food product weight, and a geographic identifier.

6. The method of claim 1, wherein the food pricing algorithm comprises a deterministic food pricing equation.

7. The method of claim 1, wherein the food pricing algorithm comprises a machine learning algorithm.

8. The method of claim 7, wherein the machine learning algorithm is selected from the group consisting of TensorFlow, NaiveBayes, Logistic Regression, and Random Forest.

9. A computer system for facilitating trading of a food product, comprising:
a processor; and
a memory coupled with and readable by the processor and storing therein a set of instructions which, when executed by the processor, causes the processor to facilitate trading of a food item by:
(a) receiving, by a pricing engine server, a request for a food product price;
(b) authenticating, by an authentication server, the request according to a secure authentication algorithm;
(c) parsing, by the authentication server, the request to identify one or more request parameters contained within the request;
(d) normalizing, by a normalization server, the one or more request parameters;
(e) constructing, by the pricing engine server, one or more data structures, the one or more data structures collectively comprising the one or more normalized request parameters;
(f) storing, by the pricing engine server, the one or more data structures in a computer memory;
(g) parsing, by one or more pricing variable servers, at least one of the one or more data structures to determine one or more food pricing variables based on at least one of the one or more normalized request parameters;
(h) calculating, by a price calculation server and according to a food pricing algorithm, a food product price based on the one or more food pricing variables; and
(i) displaying, by the pricing engine server, the food product price in a graphical user interface.

10. The system of claim 9, wherein at least two of the pricing engine server, the authentication server, the normalization server, the one or more pricing variable servers, and the price calculation server are the same server.

11. The system of claim 9, wherein each of the pricing engine server, the authentication server, the normalization server, the one or more pricing variable servers, and the price calculation server is a separate server.

12. The system of claim 9, wherein the secure authentication algorithm is selected from the group consisting of OAuth and SAML.

13. The system of claim 9, wherein at least one of the one or more request parameters is selected from the group consisting of a food product name, a price format, a food product weight, and a geographic identifier.

14. The system of claim 9, wherein the food pricing algorithm comprises a deterministic food pricing equation.

15. The system of claim 9, wherein the food pricing algorithm comprises a machine learning algorithm.

16. The system of claim 15, wherein the machine learning algorithm is selected from the group consisting of TensorFlow, NaiveBayes, Logistic Regression, and Random Forest.

17. A computer system for facilitating trading of a food product, comprising:
a pricing engine;
an authentication service;
a normalization service;
at least one food product pricing variable service; and
a price calculation service,
wherein the pricing engine receives a data structure comprising user credentials and a food product pricing request from a user computer, parses the data structure, and communicates the user credentials and the at least one price request parameter to the authentication service,
wherein the authentication service applies a secure authentication algorithm to the user credentials, parses the food product pricing request for at least one request parameter, and communicates a validation and the at least one request parameter to the pricing engine,
wherein the pricing engine communicates the at least one request parameter to the normalization service,
wherein the normalization service normalizes the at least one request parameter and communicates one or more normalized parameters to the pricing engine,
wherein the pricing engine communicates at least one of the one or more normalized parameters to the at least one food product pricing variable service,
wherein the at least one food product pricing variable service applies a set of logical filtering elements to the at least one normalized parameter to produce a filtered food pricing variable and communicates the filtered food pricing variable to the pricing engine,
wherein the pricing engine communicates the filtered food pricing variable to the price calculation service,
wherein the price calculation service calculates a food product price based on the filtered food pricing variable according to a pricing algorithm and communicates the food product price to the pricing engine, and
wherein the pricing engine displays an indicator in a graphical user interface of the user computer, the indicator corresponding to the food product price.

18. The system of claim 17, wherein the secure authentication algorithm is selected from the group consisting of OAuth and SAML.

19. The system of claim 17, wherein the pricing algorithm comprises a deterministic pricing equation.

20. The system of claim 17, wherein the pricing algorithm comprises a machine learning algorithm.
